(19) United States
(12) Patent Application Publication
(10) Pub. No.: US 2001/0050360 A1
(43) Pub. Date: Dec. 13, 2001

(54) Lifting column provided with linear transducer

(76) Inventor: Paolo Barbagallo, Prato (IT)

Correspondence Address: James V. Costigan, Esq., HEDMAN, GIBSON & COSTIGAN, P.C., 1185 Avenue of the Americas, New York, NY, 10036-2601, US

(21) Appl. No.: 09/745,944

(22) Filed: Dec. 22, 2000

(30) Foreign Application Priority Data
Feb. 29, 2000 (EP) 00104133.4

(51) Int. Cl. B60S 9/02

(52) U.S. Cl. 254/418; 33/710

(57) ABSTRACT

A lifting column provided with a powered lifting mechanism (3, 4, 5) which moves a loading bucket (7) along the vertical axis of the column. The column comprises a linear transducer (20, 30) which directly measures the height reached by the loading bucket and continuously transmits the read values to a computer unit (33). The invention further relates to an apparatus comprising a plurality of such columns and a central unit which compares the height of the various bucket and control the power group of the columns in order to maintain the various heights at the same level.

### FIELD OF THE INVENTION

The present invention relates to a measurement system intended to determine the displacement of a movable body in respect to a fixed reference.

In particular, the system is intended to the measurement of the height reached by the lifting thrust of a lifting apparatus of the type comprising a plurality of independent columns provided of thrusts engaged with the wheels or other points of heavy vehicles in order to permit maintenance or any other operations.

### BACKGROUND OF THE ART

Lifting columns are already known, which include a base element, a vertical member housing the lifting mechanism and a power group operating the lifting mechanism.

The lifting mechanism of these columns substantially consists of a vertical endless screw, or spindle, engaging a threaded nut which can move vertically and which supports an horizontal loading bucket, or thrust, able to be placed under a wheel or an other point of a vehicle.

The power group, generally placed on the top of the vertical element, rotates the spindle by a suitable gear mechanism and is provided with an encoder device able to read the number of revolutions of the spindle or of the gear connection mechanism.

Furthermore, a computer unit ensures that all the wheels of the vehicle are contemporaneously lifted, the unit being able to determine, and compare, the height reached by the various loading buckets (and thus by the vehicle wheels resting on the buckets) as a result of the number of revolutions read by the encoder device.

Thus, the height of the buckets is determined on the basis of a incremental measuring system which reads the pulses emitted by a sensor placed on the top of the spindle.

Unfortunately, the already known lifting column systems present some drawbacks due to the fact that the measurement of the height of the buckets is not direct, so that a possible failure of the lifting mechanism is not revealed by such system.

For example, if the spindle cracks or the engagement between the power group and the spindle fails, the bucket stops its lifting motion but the control system continues to read the revolutions of the gear mechanism connected to the spindle. Thus, the wheel lifted by this column remains at a lower height than the other wheels and this causes a risk for the stability of the vehicle and for the safety of the operators.

Furthermore, when incremental measuring devices are utilised, the possible measurement errors (due to a loss of pulses or to “false” pulses) are added to the “true” measurement and can not be removed before the next measurement reset which generally occurs at the end stroke point of the loading bucket.

### Aim of the Invention

A first aim of the invention is to provide a highly reliable lifting apparatus of heavy vehicles which permits the user to read directly, and to compare, the height reached by the lifting buckets of a plurality of independent columns.

A second aim of the invention is to provide a lifting apparatus of easy and safe use for the operators and suitable to satisfy the requirements of the safety standards.

### SUMMARY OF THE INVENTION

The above said aims have been reached according to the invention by a lifting apparatus of heavy vehicles comprising a plurality of independent columns each of them is provided with a powered lifting mechanism which moves a loading bucket along the vertical axis of the column. Each column comprises a linear transducer which directly measures the height reached by the loading bucket and continuously transmits the read values to a computer unit which compares the height of the various bucket and control the power group of the columns in order to maintain the various heights at the same level.

In the described embodiment the transducer comprises a vertical tape applied to the body of each column and of at least one array of optical sensors, integral with the vertical motion of the loading bucket, which can read from a binary meter printed on the tape the bit value corresponding to the current height and extracts a measure therefrom according to a predetermined binary code.

In a preferred embodiment two arrays of optical sensors are provided, the first one integral to the bucket and the second one integral to a safety nut engaged with the endless screw. In this case it is possible to read the changes of the height difference of the arrays as a result of the wearing of the active nut supporting the bucket or of a failure of the lifting mechanism or of a failure of the reading device. The lifter comprises also a computer unit able to receive the measurement data from the various columns and compare them in order to reveal possible failures and then to control, or to stop if needed, the power groups of the lifting mechanisms.

A first advantage consists in that for each column a direct height measurement is performed, this resulting in high reliability and safety of the whole lifting apparatus.

A second advantage consists in the possibility to verify the wearing status of the active nut which directly support the loading bucket.

A third advantage consists in that it is not necessary to gauge the measuring system.

A forth advantage consists in that possible obstacles under the bucket can be detected.

A fifth advantage consists in that it is not necessary to install end stroke sensors and that the overtaking of the end stroke points (due for example to inertial forces or to a delay of the control system) can be easily controlled.

A sixth advantage consist in that the apparatus is substantially unaffected by EM fields.

These and further advantages will be evident from the following drawings given as a non limiting example of the invention in which:

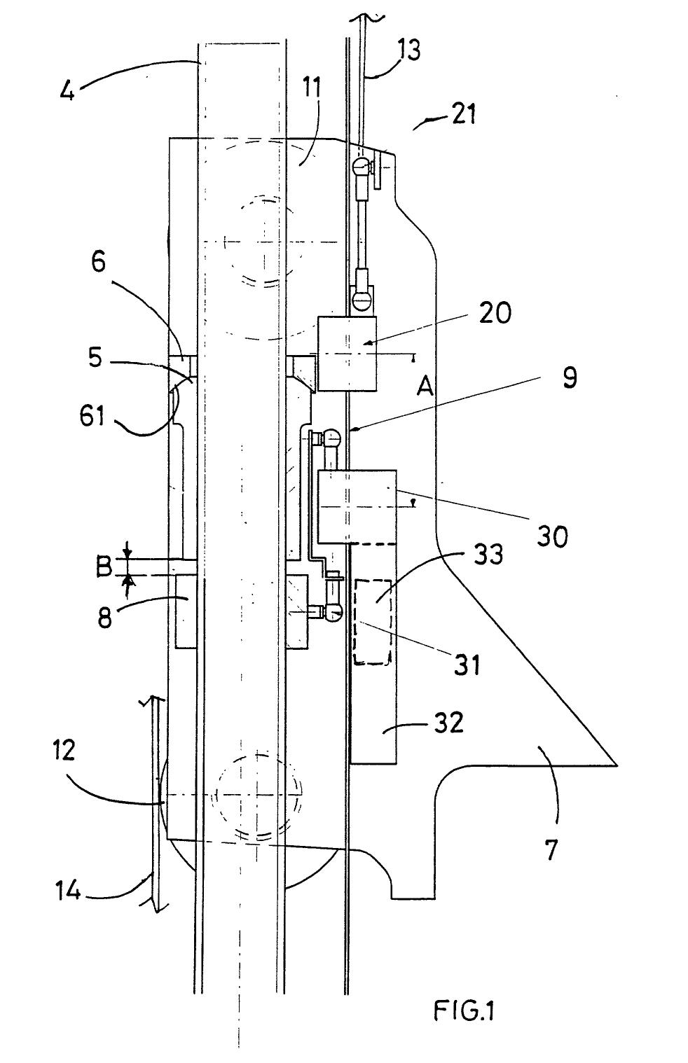

FIG. 1 shows a detail of the lifting mechanism and of the measuring system of the invention;

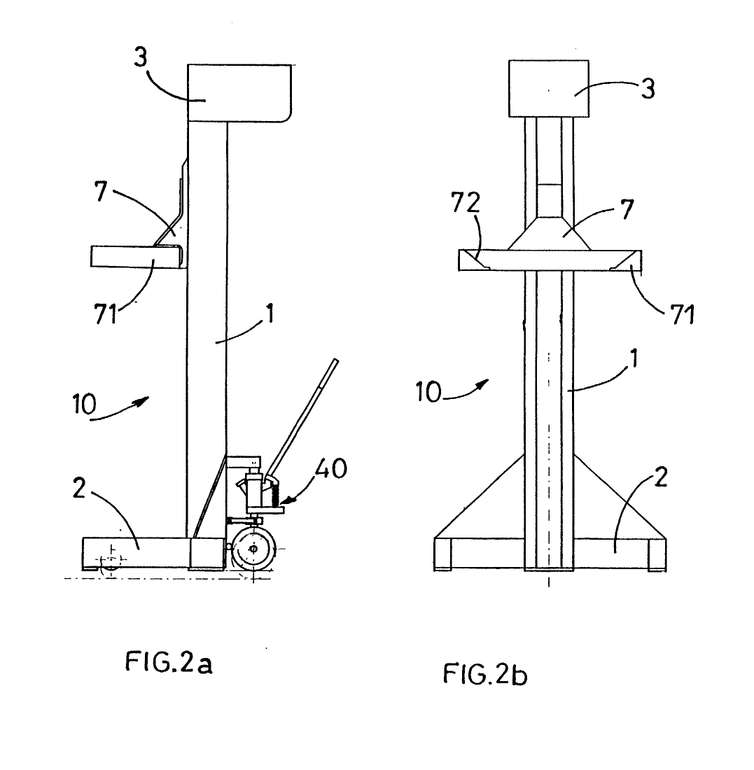

FIG. 2a and 2b respectively show a side and a front view of a lifting column according to the invention.

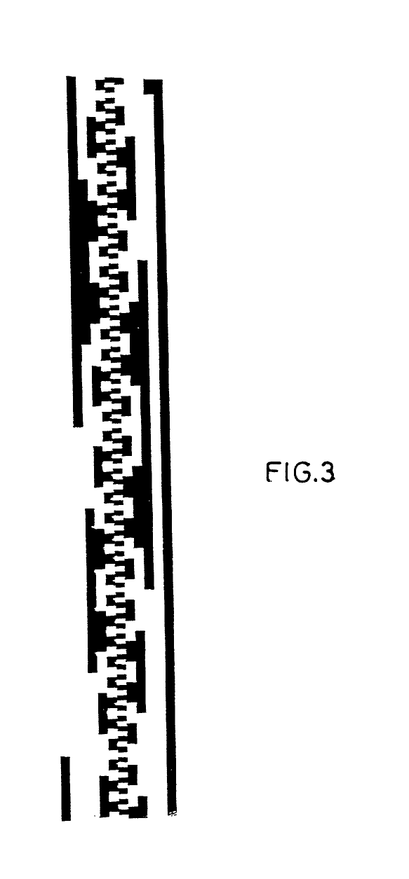

FIG. 3 schematically shows a binary meter utilised in a preferred embodiment of the invention.

### DETAILED DESCRIPTION OF THE INVENTION

With reference to the embodiment illustrated in the annexed drawings, a lifting apparatus according to the invention comprises at least one lifting column 10 constituted by a vertical shoulder 1 containing the lifting mechanism and supported by a base element 2. Element 2 is provided with a trolley 40 by which it is possible to displace the column 10 to the working point.

On the top of the vertical shoulder there is provided a power group 3 rotating an endless screw or spindle 4 by a “in se” known gear mechanism.

An upper active nut 5 is engaged with the spindle 4 and presents an upper spherical surface 51 which is able to push on the corresponding lower surface of a support ring 6. Ring 6 is mounted in a corresponding seat 61 of a thrust 7 which can vertically slide along the vertical shoulder 1 being guided by four rolls 11, 12 respectively rotating on the front and rear vertical walls 13, 14 of the shoulder 1.

A lower safety nut 8 is engaged with the spindle 4 at a distance B from the active nut 5 which is approximately equal to the pitch of the endless screw 4.

In the described embodiment a plate 71 is supported by the thrust 7 and presents an internal conical surface 72 intended to house a wheel of the lifted vehicle.

However, different shapes can be used in order to house different lifting points of a vehicle.

According to the invention a binary optical meter is printed on the external surface of a vertical tape 9 applied to the shoulder 1.

A first optical reader 20 is connected by a rod 21 to the thrust 7, so that the reader 20 moves together with the thrust 7 and is able to directly and continuously read the optical meter of the tape 9 in order to determine the height of the thrust 7 on the basis of the read binary value. In the described embodiment the resolution of the binary meter is approximately equal to 1 mm.

A second optical reader 30 is connected by a rod 31 to the safety nut and is able to directly and continuously read the optical meter of the tape 9 and to determine therefrom the height of the nut 8.

In the described embodiment, the case 32 of the reader 30 houses a microprocessor unit 33 connected with both the readers and controlling the reading operations and the processing of the read data.

The lifting apparatus further comprises at least one computer central unit (not shown in the drawings) able to control the functioning of the lifting columns 10 which are utilised to lift the vehicle. The central unit receives from the microprocessor units 33 the reading data and process the latter in order to suitably control the power groups 3 of the columns 10.

During operation, and with reference to FIG. 1, the thrust 7 of each column is placed under a wheel of the vehicle to be lifted. Thus, sensors 20, 30 can directly read from the binary meter the value of the initial height of the thrust and of the safety nut 8 at the start position.

Then, the lifting mechanism of each column is operated by the central unit and the power group 3 rotates the spindle 4 so that the thrusts 7 of the independent columns move upwardly contemporaneously lifting the wheels of the vehicle up to a work position.

While the thrusts 7 of the different columns are displacing , the readers 20 read directly from the tape 9 the heights of the corresponding thrusts so that the units 33 can continuously send the read heights to the central unit and the latter can compare them in order to keep the heights equal and to guarantee the static stability of the lifted vehicle.

Through the double reading performed by sensors 20 and 30, the unit 33 can also verify the occurrence of “false” readings by comparing the height values read by readers 20 and 30.

These heights differ of a fixed value A, corresponding to a predetermined initial distance between the reading points of the readers 20, 30, so that the unit 33 can continuously verify that said distance between the readers 20 and 30, i.e. the distance between a first point integral with the thrust and a second point integral with the safety nut, does not change during the strokes.

If a change occurs, for example when the distance between readers 20, 30 becomes shorter than the predetermined value, that can be caused by a failure of the active nut (which falls on the safety nut so that margin B is drastically reduced) or by the wearing of the active nut which results in a reduced distance between active nut and safety nut (margin B becomes progressively shorter ).

In this cases the central unit will be able to stop the apparatus (first case, the distance changes abruptly) or to evaluate the remaining life of the active nut and to provide, if needed, to its replacement.

During the stroke of the thrust from the upper position back to the start position, if the distance between readers 20 and 30 increases, that means that the thrust 7 has been stopped or hindered by an obstacle, while nut 8 is continuing its stroke. Even in this case the central unit will be able to stop of the lifting columns.

As a further example, when the gear mechanism of the power group of a column fails, the spindle stops to rotate, but the readers continue to read the same height. Even in this case, according to the invention, the central unit of the lifting system is informed from the direct reading of readers 20, 30 that something is wrong and that the other columns have to be stopped.

In any case, the apparatus of the invention is able to verify any kind of failure and to perform a continuous monitoring and a diagnostic analysis of the whole system. In the described embodiment, the readers consist of arrays of optical sensors and the binary meter is printed on a tape applied to the column. However, different sensors and transducers can be utilised and other ways to apply the meter to the columns can be designed without departing form the scope of the invention. For example, the binary code meter can be directly impressed on the column surface. The invention has been described with reference to a particularly advantageous application to a column lifting apparatus, but the described reading system can be utilised for any applications where an easy and efficient direct reading of a quote (or of a distance) is needed without outgoing from the scope of the invention.

1. Lifting column comprising a vertical shoulder (1) and a lifting thrust (7) displaced along said shoulder by an upper power group (3), characterized in that it comprises a linear transducer able to read and to transmit to a microprocessor unit the height values of said thrust.

2. Lifting column according of claim 1, wherein said transducer consists of a fixed part integral to the shoulder and a movable part integral to said thrust.

3. Lifting column according of claim 2, wherein said fixed part is a vertical linear meter applied to said shoulder; and said movable part comprises at least one linear reader (20) applied to a first body integral to said thrust and directly coupled with said meter; a microprocessor unit (33) receiving the data read by the reader (20) and able to process these data in order to extract therefrom the displacement value of the thrust.

4. Lifting column according to claim 3 wherein said thrust (7) is supported by a first nut (5) vertically displaced by a spindle (4) operated by group (3) and housed inside said shoulder.

5. Lifting column according to claim 4, wherein nut (5) presents an upper spherical surface (51) supporting a corresponding lower surface of a support ring (6) mounted in a corresponding seat (61) of the thrust (7).

6. Lifting column according to claim 3, wherein it comprises a second reader (30) fixed to a second movable body (8) and coupled with said meter at a prefixed distance (A) from said first reader (20).

7. Lifting column according to claim 6, wherein said second movable body is a safety nut (8) vertically displaced by said spindle (2).

8. Lifting column according to claim 7 wherein said safety nut (8) is engaged with the spindle (4) at a prefixed distance (B) from the first nut (5).

9. Lifting column according to claim 6 wherein at least one of said optical readers (20, 30) performs a continuous reading of the binary meter and sends the read data to the unit (33).

10. Lifting column according to claim 8 wherein the case (32) of the reader (30) houses the microprocessor unit (33) connected with both the readers and controlling the reading operations and the processing of the read data.

11. Lifting column according to claim 9, wherein said microprocessor unit continuously processes the data received from the optical readers (20,30) and compares the displacement values of thrust (7) and nut (8).

12. Lifting column according to claim 1, wherein said linear meter is a binary optical meter and said readers (20, 30) are optical readers.

13. Lifting column according to claim 11, wherein said binary meter is printed on a vertical tape (9) applied to said shoulder (1).

14. Lifting column according to claim 11, wherein said binary meter is printed on a vertical tape (9) applied to said shoulder (1).

15. Lifting column according to claim 6, wherein said readers consist of an array of optical sensors.

16. Lifting column according to claim 1, wherein said thrust (7) can vertically slide along the shoulder (1) being guided by four rolls (11, 12) rotating on vertical walls of the shoulder.

17. Lifting column according to claim 1, wherein shoulder (1) is supported by a base element (2) provided with a trolley (40) by which it is possible to displace the column.

18. Lifting column according to claim 1, wherein said microprocessor unit continuously processes the height values received from said transducer.

19. Lifter apparatus comprising a plurality of lifting columns (10) according to at least one of claims 1-18 and provided with a central microprocessor unit able to receive from each unit (33) the processed data referring to the height values received from said transducer and to control the power group (3) of each column (10) in order to guarantee the static stability of the lifted load.
